(19) United States
(12) Patent Application Publication
(10) Pub. No.: US 2019/0185144 A1
(43) Pub. Date: Jun. 20, 2019

(54) Wheel-Strut Stabilization System for Suspended Payload Aircraft

(71) Applicant: Thomas MCNALLY, Philadelphia, PA (US)

(72) Inventor: Thomas MCNALLY, Philadelphia, PA (US)

(21) Appl. No.: 15/762,671

(22) PCT Filed: Sep. 8, 2016
(86) PCT No.: PCT/US16/50601

§ 371 Date: Mar. 23, 2018

Related U.S. Application Data
(60) Provisional application No. 62/215,940, filed on Sep. 9, 2015.

(51) Int. Cl. B64C 25/04; B64C 25/06; B64C 39/02; B64D 9/00

(52) U.S. Cl. CPC B64C 25/04; B64D 9/003; B64C 39/02; B64C 25/06

(57) ABSTRACT

A payload transport aircraft that includes a nacelle including a cockpit, a first wing extending in a first direction from the nacelle and a second wing extending in a second direction from an opposing side of the nacelle. The aircraft also includes a first pair of wheel-struts extending between the first wing and a first set of corresponding wheels and a second pair of wheel-struts extending between the second wing and a second set of corresponding wheels. Each member in the pair of wheel-struts is connected by a wheel-strut stabilizing segmented cross-bar having a rear segment and a front segment joined at a disconnection point by one or more coil-springs, which can be tension springs resistant to stretching mounted to each segment through the use of spring mounting-posts fitted into each segment and protected using a cover that can be removable and transparent for quick visual inspection.

### CROSS REFERENCE TO RELATED APPLICATIONS

This application claims the benefit of U.S. Provisional Application No. 62/215,940, filed on Sep. 9, 2015, which is incorporated herein in its entirety.

### TECHNOLOGY FIELD

The present application relates generally to an aircraft for transporting payloads, and in particular, to a fixed-wing aircraft for transporting large International Organization for Standardization (ISO) intermodal shipping-containers, other types of containers, and miscellaneous cargo.

### BACKGROUND

The shipping industry employs and transports various ISO standardized intermodal shipping-containers for storage and transport of materials and products around the world. Intermodal indicates that the containers may be transferred from one mode of transport to another without unloading and reloading the contents of the container, reducing cargo handling and thereby improving security, reducing damage and loss, and allowing for faster, more direct, and less expensive aerial transport.

Conventional modes of transporting ISO intermodal shipping-containers include ship, rail, and truck. Some areas of the world, however, are not adequately accessible or accessible at all by ship, rail, or truck. Further, even with adequate infrastructure, it may take days or longer to transport ISO containers by ship, rail, and truck. Although conventional transport aircraft can travel much faster and more directly than ship, train, and truck, conventional transport aircraft are not fitted for the transport of large and heavy semi-trailers, nor ISO intermodal shipping-containers, nor heavy vehicles/machinery, nor outsized payloads.

### SUMMARY

Embodiments provide a payload transport aircraft that includes a nacelle including a cockpit, a first fixed-wing extending in a first direction from beneath the cockpit and a second fixed-wing extending in a second direction from underneath an opposing side of the nacelle. The nacelle can be a housing that holds fuel tanks and equipment for the aircraft, and can house the aircraft's cockpit and support facilities (third seat, bed, galley, and toilet), partially filling the function of a conventional fuselage. The aircraft also includes a first pair of wheel-struts extending between the first fixed-wing and a first set of corresponding wheels and a second pair of wheel-struts extending between the second fixed-wing and a second set of corresponding wheels.

According to another embodiment, the payload interface system is a top-lift payload interface system including a plurality of movable engaging elements extending from the nacelle and wings and a rack. The rack includes a plurality of cross supports. Each cross support extends a width between the first pair of wheel-struts and the second pair of wheel-struts. The rack also includes a pair of opposing side supports, each side support extending a length substantially perpendicular to the width and a plurality of teeth spaced from each other and extending from the pair of opposing side supports. The plurality of teeth are configured to receive the plurality of engaging elements within spaces between the plurality of teeth and the plurality of movable engaging elements are configured to lower the rack from the nacelle and wings, and raise the rack toward the nacelle and wings.

In one embodiment, the top-lift payload interface system is configured to adjust the payload along the length of the pair of opposing side supports. In an aspect of the embodiment, the top-lift payload interface system further includes a first fairing disposed at one end of the rack and a second fairing disposed at an opposite end of the rack. The fairings are configured to: (i) open to facilitate loading and unloading of the payload; and (ii) close to facilitate enhanced aerodynamics during flight. In another aspect of the embodiment, the top-lift payload interface system further includes a container engagement system configured to secure the payload to the rack.

In another embodiment, the payload interface system is a drive-through payload interface system that includes a plurality of movable engaging elements extending from the nacelle and wings, and a payload holding compartment configured to receive the payload. The payload holding compartment includes a top rack having: (i) a plurality of cross supports extending a width between the first pair of wheel-struts and the second pair of wheel-struts; (ii) a pair of opposing side supports extending a length substantially perpendicular to the width; and (ii) a plurality of teeth spaced from each other, extending from the pair of opposing side supports and configured to receive the plurality of engaging elements extending from the nacelle and wings to secure the payload to the nacelle and wings. The payload holding compartment also includes a bottom cargo deck having: (i) a plurality of cross supports extending a width between the first pair of struts and the second pair of wheel-struts; and (ii) a pair of opposing side supports extending a length substantially perpendicular to the width. The payload holding compartment further includes a pair of opposing side walls extending between the top rack and bottom cargo deck. The plurality of movable engaging elements are configured to lower the payload holding compartment from the nacelle and wings to the surface and raise the payload holding compartment toward the nacelle and wings.

In an aspect of an embodiment, the payload holding compartment further includes a main compartment body and expandable bellows disposed at opposing ends of the main compartment body, the expandable bellows configured to expand and retract to facilitate payloads of different sizes.

In another aspect of an embodiment, the payload holding compartment further includes a first fairing disposed at one end of the payload holding compartment and a second fairing disposed at an opposite end of the payload holding compartment. The fairings are configured to: (i) open to facilitate loading of the payload into the holding compartment and unloading of the payload from the payload holding compartment; and (ii) close to provide aerodynamics.

In yet another aspect of an embodiment, the payload holding compartment further includes a plurality of columns extending between the top rack and bottom cargo deck and configured to provide load paths to distribute a load exerted by the payload from the bottom cargo deck to the top rack.

According to another embodiment, the convertible payload transport aircraft further includes pivotable latches coupled to the first pair of wheel-struts and the second pair of wheel-struts and configured to pivot between upright standby positions and engaged locked positions to limit or prevent movement of the payload.

Embodiments provide a convertible payload transport aircraft that includes a nacelle including a cockpit, a pair of fixed-wings extending in opposite directions from the nacelle and a plurality of wheel-struts extending between the pair of fixed-wings and corresponding wheels. The aircraft also includes a top-lift payload interface system disposed under the nacelle and wings, and configured to be coupled to a payload, the payload interface system that includes a plurality of movable engaging elements extending from the nacelle and wings and a rack having: (i) a plurality of cross supports extending widthwise; (ii) a pair of opposing side supports extending lengthwise substantially perpendicular to the width; and (iii) a plurality of teeth spaced from each other and extending from the pair of opposing side supports. The plurality of teeth are configured to receive the plurality of engaging elements within spaces between the plurality of teeth and the plurality of movable engaging elements are configured to lower the rack from the nacelle and wings and raise the rack toward the nacelle and wings.

According to one embodiment, the top-lift payload interface system is configured to adjust the payload along the length of the pair of opposing side supports.

According to another embodiment, the convertible payload transport aircraft further includes a front fairing disposed at one end of the rack and a rear fairing disposed at an opposite end of the rack. The first fairing and the second fairing are configured to: (i) open to facilitate loading and unloading of the payload; and (ii) close to facilitate enhanced aerodynamics during flight.

In another embodiment, the top-lift payload interface system further includes a container engagement system configured to secure the payload to the rack.

Embodiments provide a convertible payload transport aircraft that includes a nacelle including a cockpit, a pair of fixed-wings extending in opposite directions from beneath the cockpit and a plurality of wheel-struts extending between the pair of fixed-wings and corresponding wheels. The aircraft also includes a drive-through payload interface system disposed under the nacelle and wings and configured to be coupled to a payload, the payload interface system that includes a plurality of movable engaging elements extending from the nacelle and wings; and a drive-through payload holding compartment configured to receive the payload. The drive-through payload holding compartment includes a top rack having: (i) a plurality of cross supports extending a width between the first pair of wheel-struts and the second pair of wheel-struts; (ii) a pair of opposing side supports extending a length substantially perpendicular to the width; and (iii) a plurality of teeth spaced from each other, extending from the pair of opposing side supports and configured to receive the plurality of engaging elements extending from the nacelle and wings to secure the payload to the nacelle and wings. The drive-through payload holding compartment also includes a bottom deck cargo having: (i) a plurality of cross supports extending a width between the first pair of wheel-struts and the second pair of wheel-struts; and (ii) a pair of opposing side supports extending a length substantially perpendicular to the width. The drive-through payload holding compartment further includes a pair of opposing side walls extending between the top rack and bottom cargo deck. The plurality of movable engaging elements are configured to lower the payload holding compartment from the nacelle and wings and raise the payload holding compartment toward the nacelle and wings.

Embodiments provide an exemplary payload transport aircraft having a nacelle that can have a cockpit in the front and an empennage in the back. A first wing can extend out of one side of the nacelle, while a second wing can extend out of the other side of the nacelle. The first wing and second wing can be fixed to the nacelle. The first wing and the second wing can be fixed to the nacelle in the same plane as the central axis of the nacelle. Alternately, the first wing and the second wing can be fixed to the main body at points located above the plane of the central axis of the main body, resembling the wing mounting of an Airbus A400M. Another alternate embodiment can have the first wing and the second wing combined into a single fixed-wing that can be attached beneath the nacelle. At least one engine can be mounted to the main body. Turboprop propeller engines are illustrated, but alternate embodiments can utilize more powerful fan-jet engines.

A pair of front wheel-struts can extend down from the first wing and the second wing. In an embodiment, the front wheel-struts and rear wheel-struts can be of such a length such that the nacelle, first wing, and second wing of the aircraft are at least ten (10) feet off the ground. In an alternate embodiment, the front wheel-struts and rear wheel-struts can be of such a length such that the nacelle, first wing, and second wing of the aircraft are at least fifteen (15) feet off the ground. In an alternate embodiment, the front wheel-struts and rear wheel-struts can be of such a length such that the nacelle, first wing, and second wing of the aircraft are at least twenty (20) feet off the ground. Alternate embodiments can alter the length of the front wheel-struts and rear wheel-struts so as to alter the general height of the aircraft based upon the dimensions of the load being transported and the dimensions of the aircraft. The ends of the front wheel-struts and rear wheel-struts can terminate in one or more wheels, used to bear the weight of the aircraft when on the ground, and during takeoff and landing. Alternate embodiments can provide the front and rear wheel-struts fitted with balloon-tires, track-treads, skis, sleds, or floats, such that the aircraft can be used in alternate environments. The wheels and wheel-struts are fixed, and are not able to be extended or retracted as in other aircraft. The payload interface system can be anchored to the front wheel-struts by using rigid interface system latches that tie it into the airframe system itself and can prevent unwanted movement of the payload interface system. The payload interface system can be similarly anchored to the rear wheel-struts using additional rigid interface system latches. When not in use, the rigid interface system latches can be folded and secured against the wheel-struts.

Embodiments provide a payload transport aircraft where the nacelle and wings can be supported off of the ground by the front wheel-struts and the rear wheel-struts, which are mounted to the wings of the aircraft. In an embodiment, the rear wheel-struts can be thicker and more substantial than the front wheel-struts, and can bear more of the aircraft's weight. An embodiment provides the rear wheel-struts extending downwards from the wings at a right angle, but alternate embodiments can provide an extension from the wings at a non-right angle. In an embodiment, the front wheel-struts can extend at a non-right angle from the wings of the aircraft, but other alternate embodiments can provide the front wheel-struts extending from the wings at a right angle. To stabilize the front wheel-struts and rear wheel-struts, a wheel-strut stabilizing segmented cross-bar can extend between the front wheel-strut and the rear wheel-strut on each side of the aircraft.

Embodiments provide a payload interface system substantially the same length as the nacelle of the aircraft, allowing for the loading of one ISO standard shipping container within the payload interface system. An alternate and larger embodiment can provide a payload interface system with the ability to load two ISO standard shipping-containers within the payload interface system. Further alternate embodiments can provide a payload interface system with the ability to load three to eight ISO shipping-containers and payload interface systems with alternate dimensions to better accommodate the different sized shipping-containers that fall within the ISO standards.

Embodiments provide a wheel-strut stabilizing segmented cross-bar having a rear segment and a front segment joined at a disconnection point by one or more coil-springs, which can be tension springs resistant to stretching mounted to each segment through the use of spring mounting-posts fitted into each segment and protected using a cover that can be removable and transparent for quick visual inspection. The rear segment and the front segment join at the disconnection point and each segment is shaped at its terminus in an “L” geometry. Alternate embodiments can provide alternate geometries that similarly provide a tight fit in order for the joined cross-bar to fully resist the compression forces associated with aircraft operation.

Embodiments provide multiple coil-springs mounted to two sets of spring mounting-posts fitted with either side of the segments. The rear segment can have a rear segment attachment section for attachment to the rear wheel-strut through the use of a rear segment fastener, while the front segment can have a front segment attachment section angled to match the incline angle of the front wheel-strut, which can attach to the front wheel-strut through the use of a front segment fastener.

Embodiments provide an exemplary payload transport aircraft without a payload or payload interface system, where an additional wheel-strut stabilizing segmented cross-bar can be attached between the two rear wheel-struts. A wheel-strut stabilizing segmented cross-bar can also be attached between the two front wheel-struts. The front cross-bar can be rotated 90 degrees around its central axis to present a more aerodynamic profile.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a front view of an exemplary payload transport aircraft having a wheel-struts stabilization system according to an embodiment disclosed herein;

FIG. 2 is a top view of an exemplary payload transport aircraft as shown in FIG. 1 with an attached payload interface system;

FIG. 3 is a side view of an exemplary payload transport aircraft as shown in FIG. 1 with an attached payload interface system;

FIG. 4 is a perspective view of top lift payload interface system;

FIG. 5 is a perspective cut-away view of a drive-through payload interface system with a payload holding compartment;

FIG. 6 is a close-up perspective view of the top lift payload interface system shown in FIG. 4;

FIG. 7 is an overhead view of a wheel-strut stabilizing segmented cross-bar;

FIG. 8 is a side view of a wheel-strut stabilizing segmented cross-bar;

FIG. 9 is an overhead view of a wheel-strut stabilizing segmented cross-bar without coil-spring;

FIG. 10 is a perspective view of a wheel-strut stabilizing segmented cross-bar connected with a rear wheel-strut;

FIG. 11 is a perspective view of a wheel-strut stabilizing segmented cross-bar connected with a front wheel-strut;

FIG. 12 is a side view of an exemplary payload transport aircraft as shown in FIG. 1 without an attached payload interface system;

FIG. 13 is a front view of an exemplary payload transport aircraft as shown in FIG. 1 without an attached payload interface system;

FIG. 14 is a top view of an exemplary payload transport aircraft as shown in FIG. 1 without an attached payload interface system.

### DETAILED DESCRIPTION OF EXEMPLARY EMBODIMENTS

The air-cargo transport industry continues to find new ways to reduce the consumption of expensive fuel and the excessive production of environmentally harmful CO₂ exhaust emissions. In terms of payload delivery, conventional airplanes are not very fuel-efficient. They also have heavy wing loadings and heavy footprints that make them incapable of accessing short-unhardened airfields. Smaller, lighter cargo airplanes have limited lift capacity and cargo handling capabilities. Other conventional aircrafts (e.g., blimps, hybrid airships) are lightweight, but are also slow and have limited flying-time windows of opportunity because of their extreme susceptibility to even moderately windy weather conditions, and they require large expensive aircraft hangers for sheltering.

Conventional prior-art cargo airplanes are neither designed nor fitted for transporting large ISO intermodal shipping-containers. For example, conventional aircraft cannot ‘top-lift’ an ISO shipping-container off the ground or off the chassis of a semi-trailer. Further, no known conventional transport aircraft has a ‘drive-through’ capability for lifting ISO intermodal shipping-containers, and dropping off semi-trailers and similar payload packages.

Embodiments include a transport aircraft devoid of the conventional fuselage, thereby eliminating weight that is reallocated to the payload. Because of this significant shift in the ratio of empty weight to payload weight, fuel consumption may be dramatically reduced up to 50% per payload ton-mile.

Embodiments include a transport aircraft that incorporates an aircraft/payload interface system for accommodating interchangeable intermodal shipping-containers, semi-trailers and general freight. Aspects of the aircraft are configured to work with two basic payload interface systems: (i) a gantry-type top-lift system intended exclusively for ISO intermodal shipping-containers, and (ii) a drive-through payload interface system with drop-off and pickup capabilities for semi-trailers and a cargo deck for all types of general freight and miscellaneous payload packages.

Embodiments include a transport aircraft configured to effectively and efficiently transport large payloads by employing a suspension-system type of airframe architecture whereby the payload is hung in suspension directly beneath the aircraft's nacelle and wings that are perched upon a set of four long wheels-struts. Embodiments include a transport aircraft without a conventional fuselage, thereby reducing structural weight and significantly increasing the aircraft's fuel efficiency (e.g., in terms of fuel consumed per payload per ton-mile delivered). To support the wheel-struts, wheel-strut stabilization segmented cross-bars can be mounted in various combinations between the four wheel-struts.

All aircraft are designed to be elastic to some degree. The structure of an aircraft cannot be completely rigid, otherwise it would crack into pieces and fall apart due to the variety of forces subjected to it during operation. An aircraft must be designed to handle different loads under extreme temperature variations. In other words, the structure must be able to flex while still maintaining structural integrity under varying conditions.

Embodiments provide a segmented cross-bar comprised of two segments that are complementarily notched so as to fit together to enable the handling of compression loads. The two segments are held together by stiff coil-springs mounted onto posts sunk into the individual cross-bar segments. The coil-springs are present to handle the tensile loads that will occur during takeoffs and landings as well as the expansions and contractions that occur due to the temperature variation between the ground and operating altitude.

Embodiments provide an aircraft costing ½ to ⅔ less than an inefficient heavier cargo aircraft with comparable lift capacity. Embodiments provide an aircraft with reduced fuel consumption of up to 40%-50% less than these heavier inefficient prior-art platforms, as well as significantly reduced maintenance costs due to far fewer moving parts.

Some embodiments provide an aircraft having a gantry-type top-lifting payload interface system configured to lift and secure the ISO intermodal shipping-container for transport. Other embodiments provide an aircraft having a drive-through payload interface system configured as a holding compartment designed to lift the secured payloads held within. The payload is driven into the payload holding compartment that in turn is lifted and secured to the aircraft airframe be means of a plurality of wheel-strut latches.

Embodiments provide an aircraft to transport semi-trailers, ISO intermodal shipping-containers, heavy vehicles and machinery, in addition to outsized payload packages. Embodiments provide an aircraft producing significantly lower lifecycle costs to develop, manufacture, operate, maintain, and insure (commercial market).

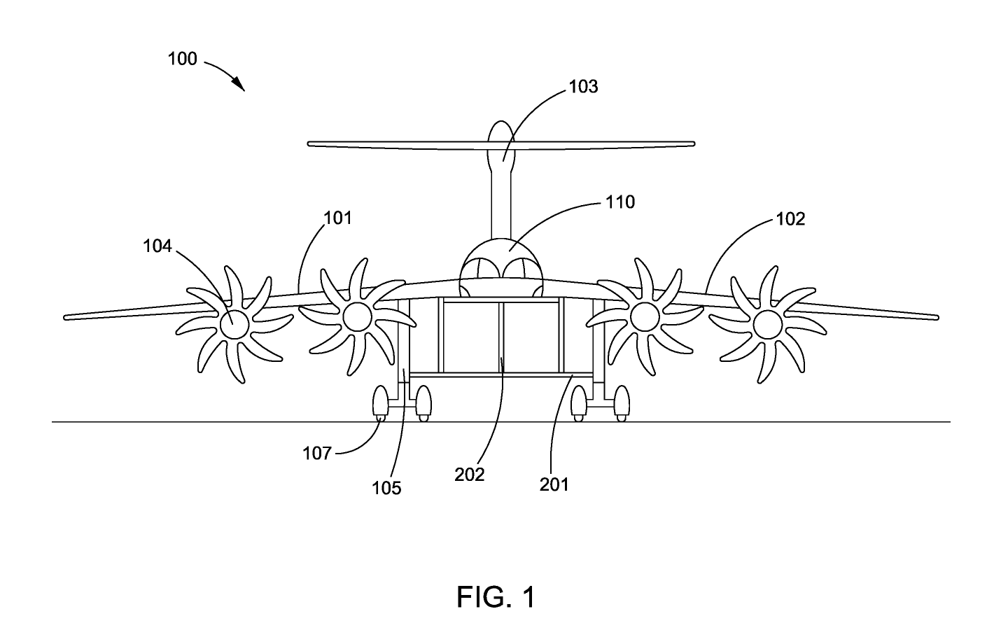

FIG. 1 is a front view of an exemplary payload transport aircraft 100 having a wheel-strut stabilization system according to an embodiment disclosed herein. The aircraft can have a nacelle (not shown in this view) that can have a cockpit 110 in the front and an empennage 103 in the back. The nacelle can be a housing that holds fuel tanks and equipment for the aircraft, and can house the aircraft's cockpit 110 and support facilities (third seat, bed, galley, and toilet), partially filling the function of a conventional fuselage. A first wing 101 can extend out of one side of the nacelle, while a second wing 102 can extend out of the other side of the nacelle. The first wing 101 and second wing 102 can be fixed to the nacelle. In an embodiment, the first wing 101 and the second wing 102 can be fixed to the nacelle in the same plane as the central axis of the nacelle. In an alternate embodiment, the first wing 101 and the second wing 102 can be fixed to the main body at points located above the plane of the central axis of the main body. This alternate configuration can resemble the wing mounting of an Airbus A400M. Another alternate embodiment can have the first wing 101 and the second wing 102 combined into a single fixed-wing that can be attached beneath the nacelle. At least one engine 104 can be mounted to the main body or the wings. Turboprop engines are illustrated, but alternate embodiments can utilize fan-jet engines.

A pair of front wheel-struts 105 can extend down from the first wing 101 and the second wing 102. In an embodiment, the front wheel-struts 105 and rear wheel-struts (not shown) can be of such a length such that the nacelle, first wing 101, and second wing 102 of the aircraft 100 are at least ten (10) feet off the ground. In an alternate embodiment, the front wheel-struts 105 and rear wheel-struts (not shown) can be of such a length such that the nacelle, first wing 101, and second wing 102 of the aircraft 100 are at least fifteen (15) feet off the ground. In an alternate embodiment, the front wheel-struts 105 and rear wheel-struts (not shown) can be of such a length such that the nacelle, first wing 101, and second wing 102 of the aircraft 100 are at least twenty (20) feet off the ground. Alternate embodiments can alter the length of the front wheel-struts and rear wheel-struts so as to alter the general height of the aircraft based upon the dimensions of the load being transported and the dimensions of the aircraft. In an alternate larger embodiment of an aircraft having larger wings and body, the length of the front and rear wheel-struts would lengthen accordingly. In an alternative smaller embodiment of an aircraft having smaller wings and body, the length of the front and rear wheel-struts would shorten accordingly.

The ends of the front wheel-struts 105 and rear wheel-struts can terminate in one or more wheels 107, used to bear the weight of the aircraft 100 on the ground, and during takeoff and landing. Alternate embodiments can provide the front and rear wheel-struts terminating in balloon-tires, track-treads, skis, sleds, or floats, such that the aircraft can be used in alternate environments. In an embodiment, the wheels and wheel-struts are fixed, and are not able to be extended or retracted as in other aircraft. The payload interface system 202 can be anchored to the front wheel-struts 105 by using rigid interface system latches 201 that can prevent unwanted movement of the payload interface system 202. The payload interface system 202 can be similarly anchored to the rear wheel-struts (not shown) using additional rigid interface system latches. When not in use, the rigid interface system latches 201 can be folded and secured against the wheel-struts.

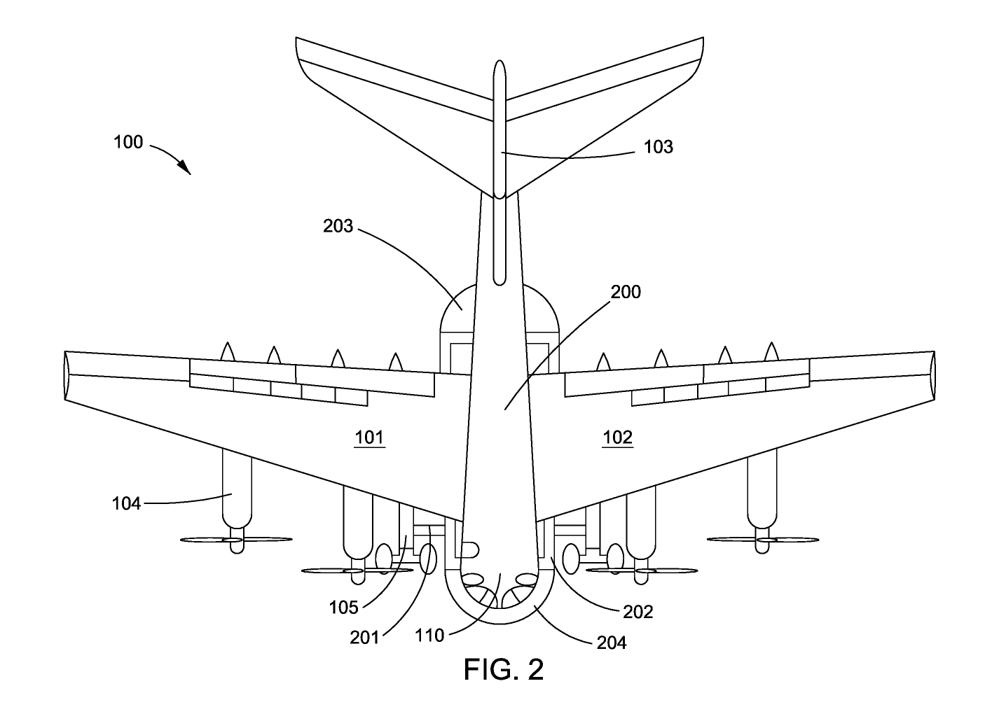

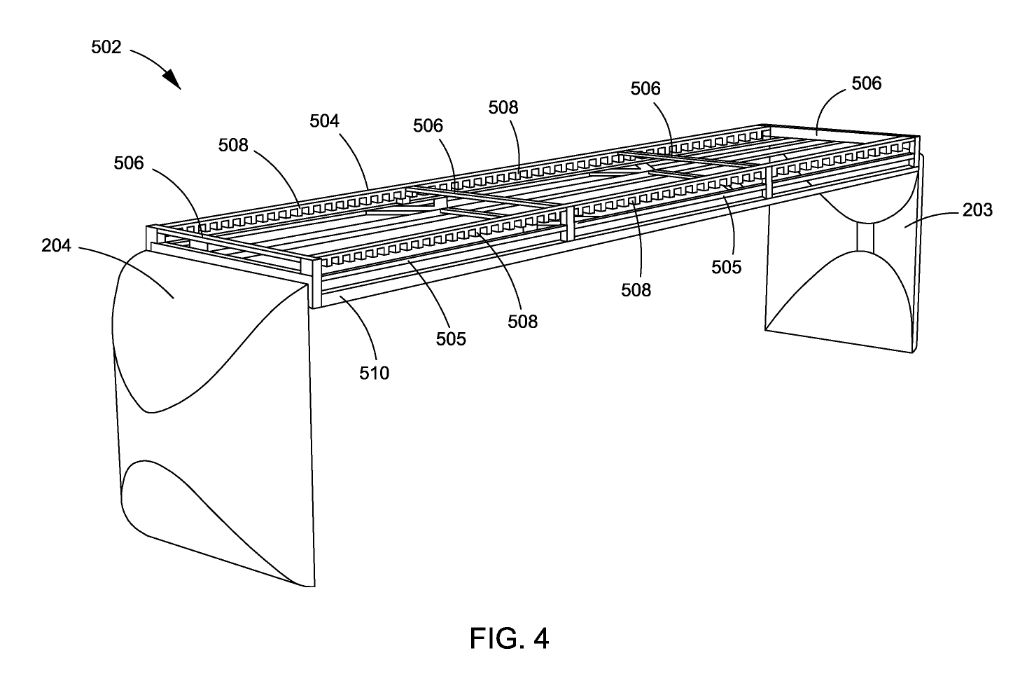

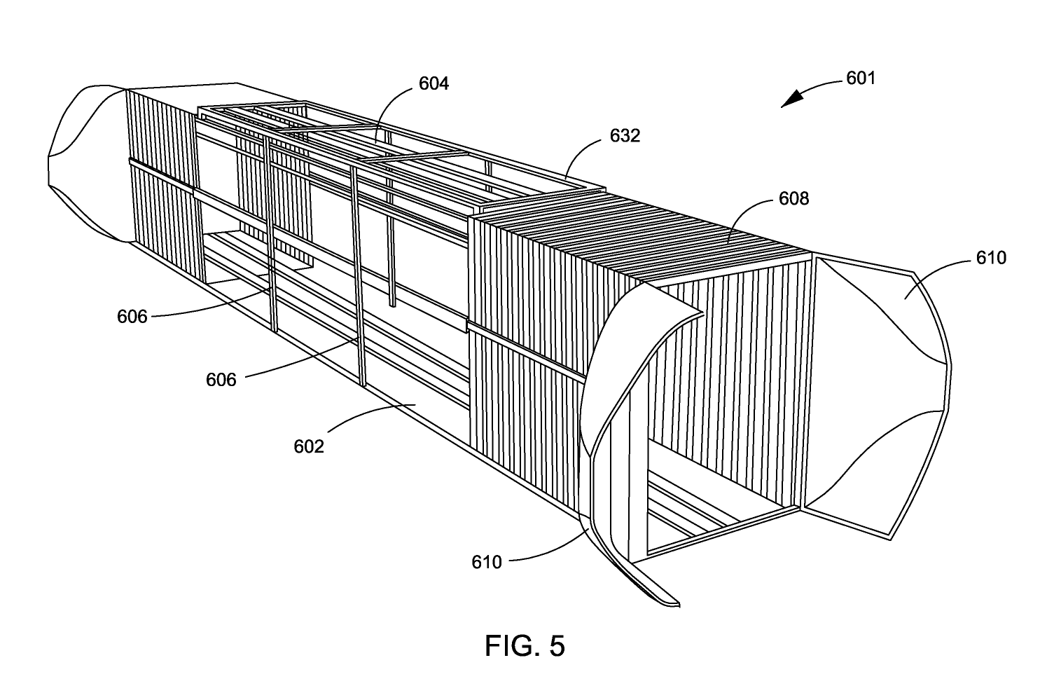

FIG. 2 is a top view of an exemplary payload transport aircraft 100 as shown in FIG. 1 with an attached payload interface system 202. The payload interface system 202 can be the top-lift payload system as described in FIG. 4 or the drive-through payload system as described in FIG. 5. In an embodiment, the nacelle 200 of the aircraft 100 can terminate at one end in a cockpit 110 and can terminate at the other end in an empennage 103. To reduce weight, the nacelle 200 can decrease in diameter, with the cockpit 110 being the widest and the nacelle section nearest the empennage 103 being the narrowest. The empennage 103 can include vertical and horizontal stabilizers and control surfaces that determine the yaw and pitch of the aircraft while in flight. In an embodiment, the nacelle can be constructed with internal trusses to evenly distribute the stress of the aircraft's various other internal components. The trusses can provide mounting points for the supplemental fuel tanks, pilot support equipment, machinery, cables, hooks or other fastening mechanisms used to secure the payload interface system 202 to the wings 101, 102 or to the nacelle 200 of the aircraft. In an alternate embodiment, the nacelle can be constructed as a monocoque or semi-monocoque shell.

The attached payload interface system 202 can have a front fairing 204 and a rear fairing 203 to enhance the payload's 202 aerodynamic characteristics while in flight, as well as to protect the payload 202 from harm during transport by the aircraft 100. The payload interface system 202 can be anchored to the front wheel-struts 105 by using rigid interface system latches 201 that can prevent unwanted movement of the payload interface system 202. The payload interface system 202 can be similarly anchored to the rear wheel-struts (not shown) using additional rigid interface system latches. When not in use, the rigid interface system latches 201 can be folded and secured against the wheel-struts.

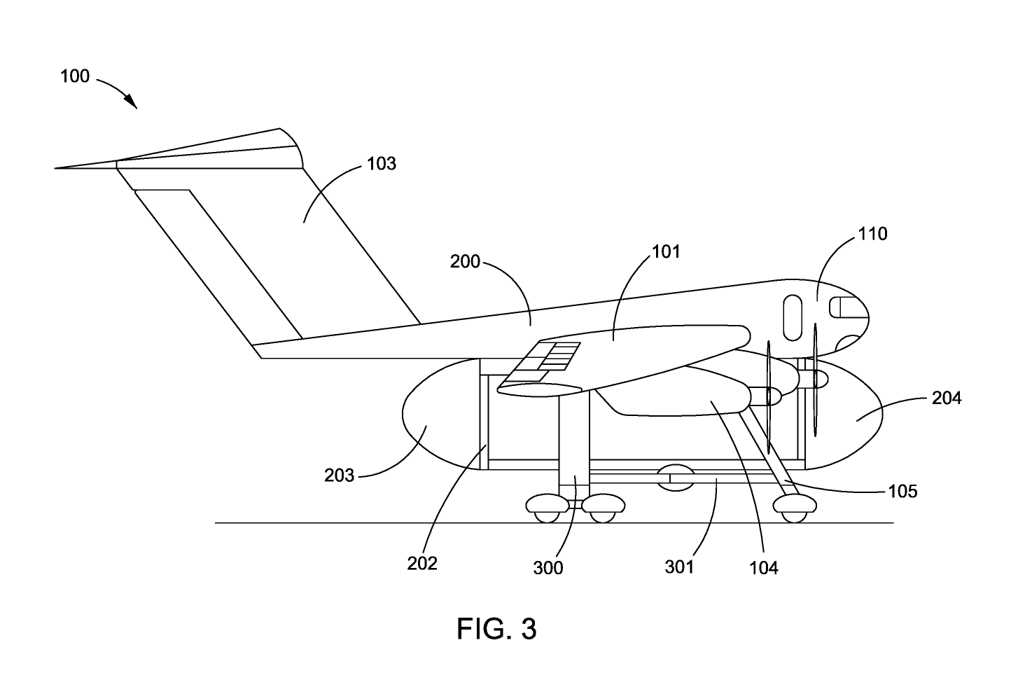

FIG. 3 is a side view of an exemplary payload transport aircraft 100 as shown in FIG. 1 with an attached payload interface system 202. In an embodiment, the payload interface system 202 with the front fairing 204 and rear fairing 203 attached can be substantially the same length as the nacelle 200 from the cockpit 110 of the aircraft 100 to the empennage 103, allowing for the loading of one ISO standard shipping-container (not shown) within the payload interface system 202. An alternate embodiment can provide a payload interface system 202 with the ability to load two ISO standard shipping-containers within the payload interface system 202. Alternate larger embodiments can provide a payload interface system 202 with the ability to load three to eight ISO standard shipping-containers within the payload interface system 202. Further alternate embodiments can provide payload interface systems 202 with alternate dimensions to better accommodate the different sized shipping-containers that fall within the ISO standards.

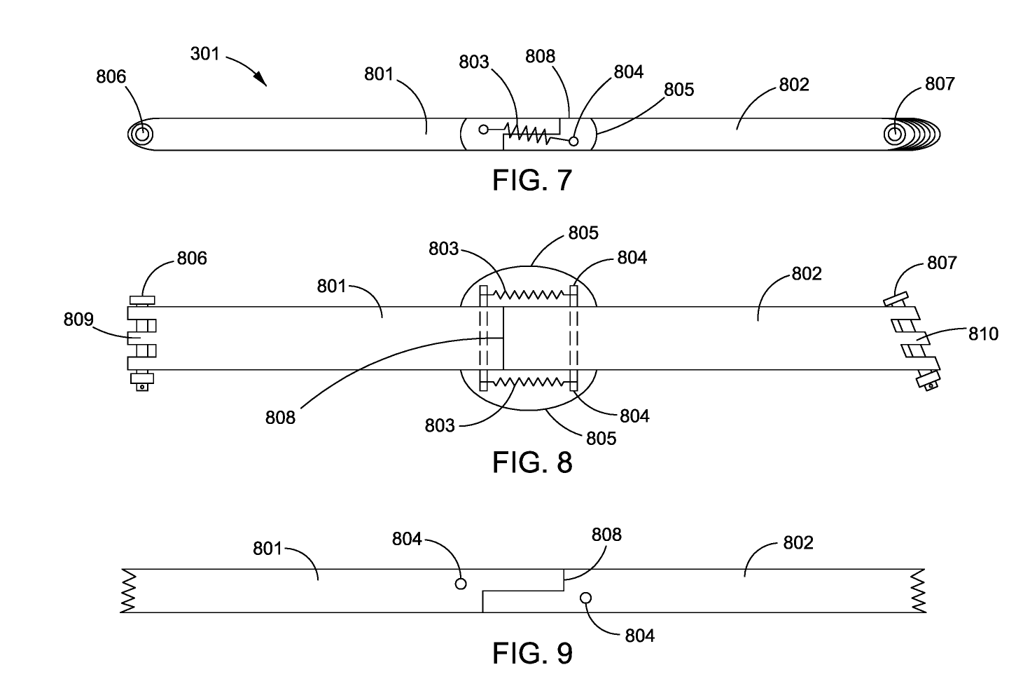

The nacelle 200 and wings 101, 102 can be supported off of the ground by the front wheel-struts 105 and the rear wheel-struts 300, which are mounted to the wings of the aircraft. In an embodiment, the rear wheel-struts 300 can be thicker and more substantial than the front wheel-struts 105, and can bear more of the aircraft's 100 weight. An embodiment provides the rear wheel-struts 300 extending downwards from the wings at a right angle, but alternate embodiments can provide an extension from the wings at a non-right angle. In an embodiment, the front wheel-struts can extend at a non-right angle from the wings of the aircraft, but other alternate embodiments can provide the front wheel-struts extending from the wings at a right angle. To stabilize the front wheel-struts 105 and rear wheel-struts 300, a wheel-strut stabilizing segmented cross-bar as described in FIGS. 7-9 301 can extend between the front wheel-strut 105 and the rear wheel-strut 300 on each side of the aircraft 100.

FIG. 4 is a perspective view of top-lift payload interface system 202. The top-lift payload interface system 202 may include a rack 504 and fairings 203, 204 disposed on opposite ends of the rack 504 to aid in flight aerodynamics. Rack 504 may include a plurality of teeth (openings) 508 configured to receive a plurality of engaging elements, such as hooks or other fasteners, which can be attached to the wings 101, 102 and/or nacelle 200. Accordingly, a shipping container (not shown) may be adjusted lengthwise along the aircraft 100 to provide a center of gravity adjustment for the container. The rack 504 may also include a plurality of side supports 505 and cross-supports 506 for providing rigidity and strength to the rack 504. The top-lift payload interface system 202 may also include a container engagement system to secure the container to the rack 504. For example, the container engagement system may include a twist lock key recess 510 configured to receive an engaging portion, such as a twist lock key (not shown) to couple the container to the rack 504.

In some embodiments, a vehicle (e.g., semi-trailer) hauling the container may drive under aircraft 100 while it is stationary and place the container in a position under the top-lift payload interface system 502 to be picked up by the top-lift payload interface system 502. The vehicle may then move away from the aircraft while the container remains with the aircraft. In other embodiments, the aircraft 100 may drive over a stationary shipping container until the container is in the position under the top-lift payload interface system 502 to be picked up by the top-lift payload interface system 502. Container may be picked up (e.g., by hooks or other fastening mechanisms fitted with the wings or nacelle) and secured at a position for transport. The center of gravity may be adjusted by: (i) determining the center of gravity of the container prior to securing the container to the aircraft 100 then securing the container to the rack 504 at a position based on the determined center of gravity of the container; or (ii) securing the container to the aircraft 100 and determining the center of gravity based on trial and error of adjusting the container along the length of the aircraft 100.

FIG. 5 is a perspective cut-away view of an alternate drive-through payload interface system 601 with a payload holding compartment 632. The payload holding compartment 632 may include a cargo deck 602, a top rack 604, columns 606, expandable bellows 608 and a pair of moveable aerodynamically shaped fairing doors 610 configured to open and close. Top rack 604 may also include a plurality of openings configured to receive a plurality of engaging elements, such as hooks, which can emanate from beneath the main fixed-wings 101, 102 or from the nacelle 200.

The payload holding compartment 632 may be configured to be lifted (e.g., by hooks) from the top of payload holding compartment 632 similar to lifting of the top-lift payload interface system 502 shown in FIG. 4. The payload holding compartment 632 of drive-through payload interface system 601, however, has a cargo deck 602 that is coupled to the top rack 604 by columns (or rods) 606 or cables. Therefore, when payload holding compartment 632 is lifted, the load (from the payload) may be distributed (e.g., uniformly) from the cargo deck 602 to the top rack 604 via load paths of the columns 606.

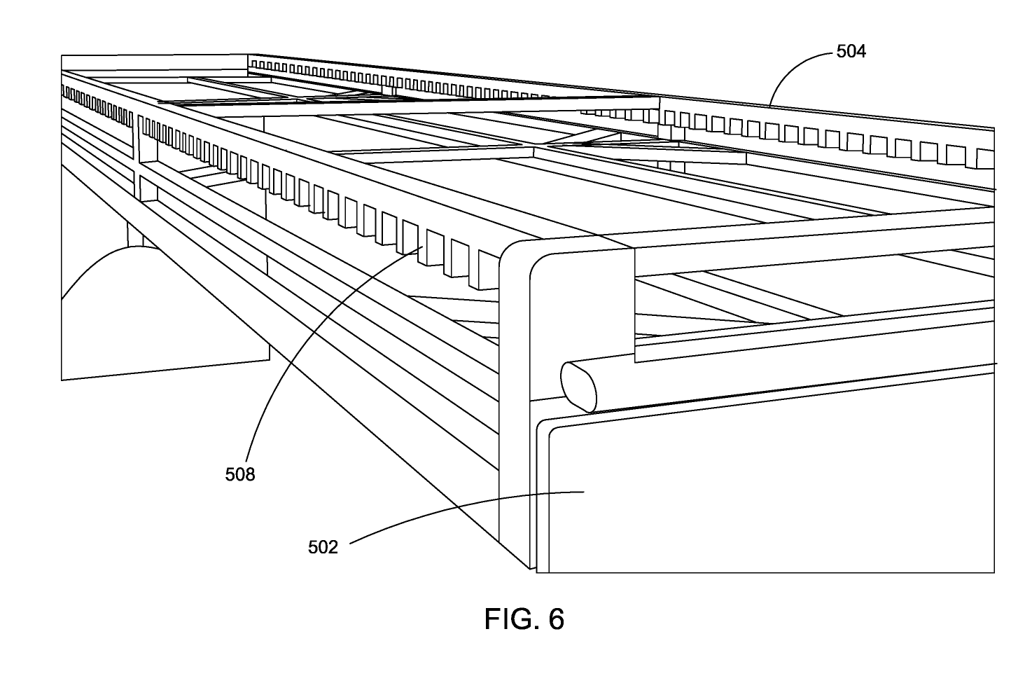

FIG. 6 is a close-up perspective view of the top-lift payload interface system 502 shown in FIG. 4.

FIG. 7 is an overhead view of a wheel-strut stabilizing segmented cross-bar 301. The cross-bar 301 can have a rear segment 801 and a front segment 802. The rear segment 801 and front segment 802 can be joined at a disconnection point 808 by one or more coil-springs 803. The coil-spring 803 can be a tension spring resistant to stretching, and can be mounted to each segment through the use of spring mounting-posts 804 fitted with each segment. In the illustrated embodiment, the rear segment 801 and the front segment 802 join at the disconnection point 808 and each segment is shaped at its terminus in an “L” geometry. Alternate embodiments can provide alternate geometries that similarly provide a tight fit in order for the joined cross-bar 301 to fully resist the compressive forces associated with aircraft operation. The coil-spring 803 and spring mounting-posts 804 can be protected using a cover 805. The cover 805 can be removable and transparent for ease of service.

FIG. 8 is a side view of a wheel-strut stabilizing segmented cross-bar 301. Multiple coil-springs 803 are mounted to two sets of spring mounting-posts 804 fitted with either side of the segments to ensure that the rear segment 801 and the front segment 802 are effectively prohibited from disjoining during aircraft operation, while still allowing for a small measure of flex during periods of normal tensile stress caused by normal aircraft operation. The rear segment 801 can have a rear segment attachment section 809 for attachment to the rear wheel-strut (not shown) through the use of a rear segment fastener 806. Similarly, the front segment 802 can have an front segment attachment section 810, angled to match the incline angle of the front wheel-strut (not shown), which can attach to the front wheel-strut through the use of a front segment fastener 807. In an embodiment, both the front segment fastener 807 and the rear segment fastener 806 can be a nut and bolt, however, alternate embodiments can provide other known removable fastening means.

As shown in this view, the covers 805 can be of sufficient diameter to cover the spring mounting-posts 804 and coil-springs 803 in order to protect them from tampering, the elements, and accidental damage. The covers 805 are removable for servicing the cross-bar components, and can be made of a transparent material to allow for rapid visual identification of any potential problems.

FIG. 9 is an overhead view of a wheel-strut stabilizing segmented cross-bar 301 without coil-spring.

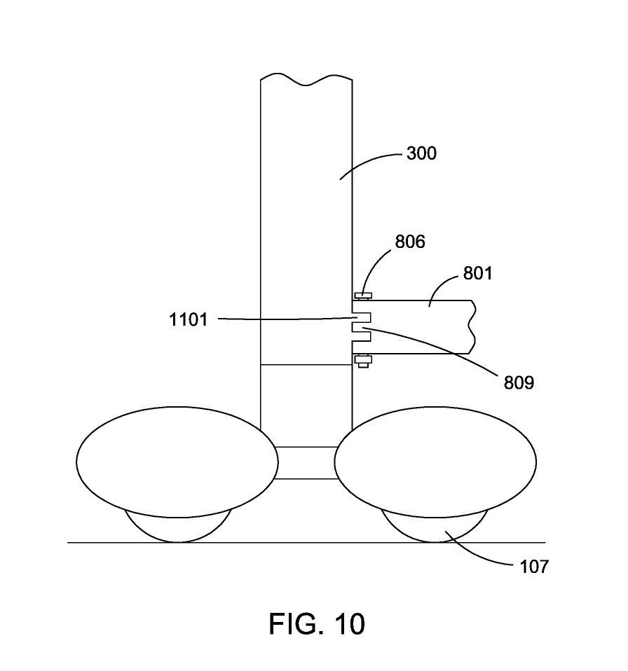

FIG. 10 is a side view of a wheel-strut stabilizing segmented cross-bar connected with a rear wheel-strut 300. The rear segment 801 of the cross-bar 301 can connect to the rear wheel-strut 300 by merging the rear segment attachment section 809 with the rear wheel-strut attachment section 1101 and engaging the rear segment fastener 806.

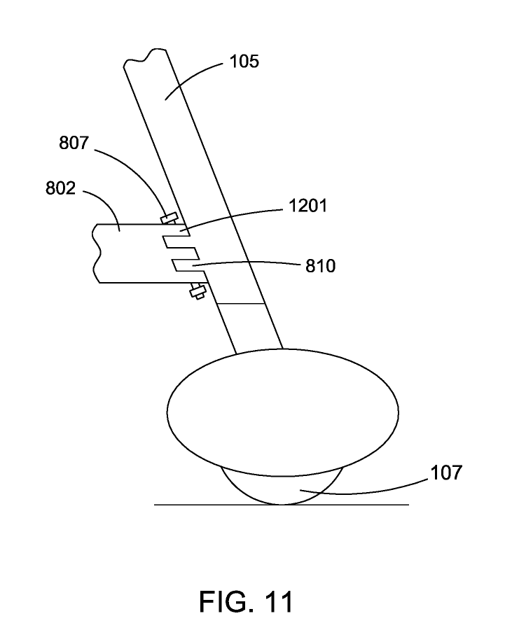

FIG. 11 is a side view of a wheel-strut stabilizing segmented cross-bar connected with a front wheel-strut 105. The front segment 802 of the cross-bar 301 can connect to the front wheel-strut 105 by merging the front segment attachment section 810 with the front wheel-strut attachment section 1201 and engaging the front segment fastener 807.

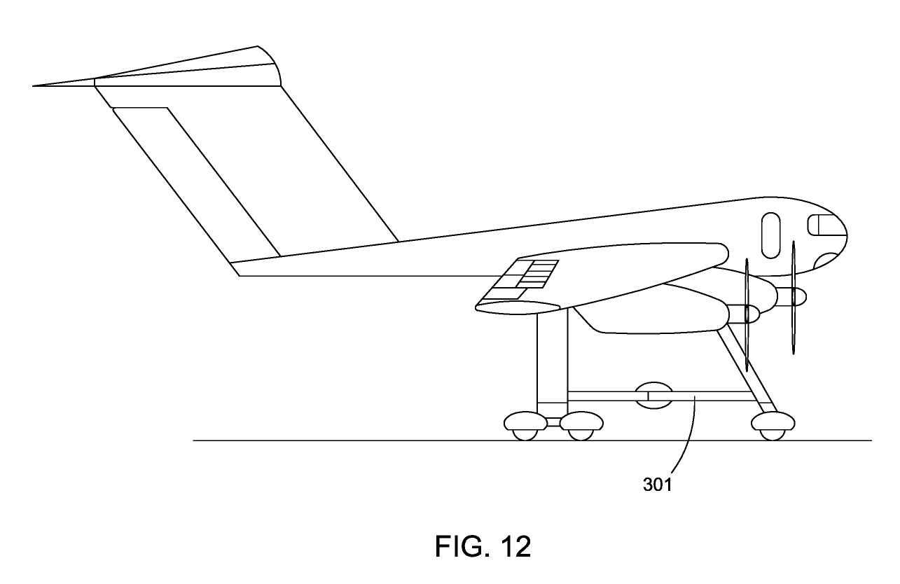

FIG. 12 is a side view of an exemplary payload transport aircraft 100 as shown in FIG. 1 without an attached payload interface system. When the aircraft 100 must fly without a payload or payload interface system, an additional wheel-strut stabilizing segmented cross-bar 301 similar to the cross-bar described in FIGS. 7-9 can be attached span-wise between the two front wheel-struts 105, while another cross-bar 301 can be attached between the two rear wheel-struts 300. The cross-bars 301 can act as dampening mechanisms that handle lateral side-loads the wheel-struts 105, 300 may encounter while the aircraft 100 is in operation without a payload and can help support the weight of the aircraft 100 while it is on the ground.

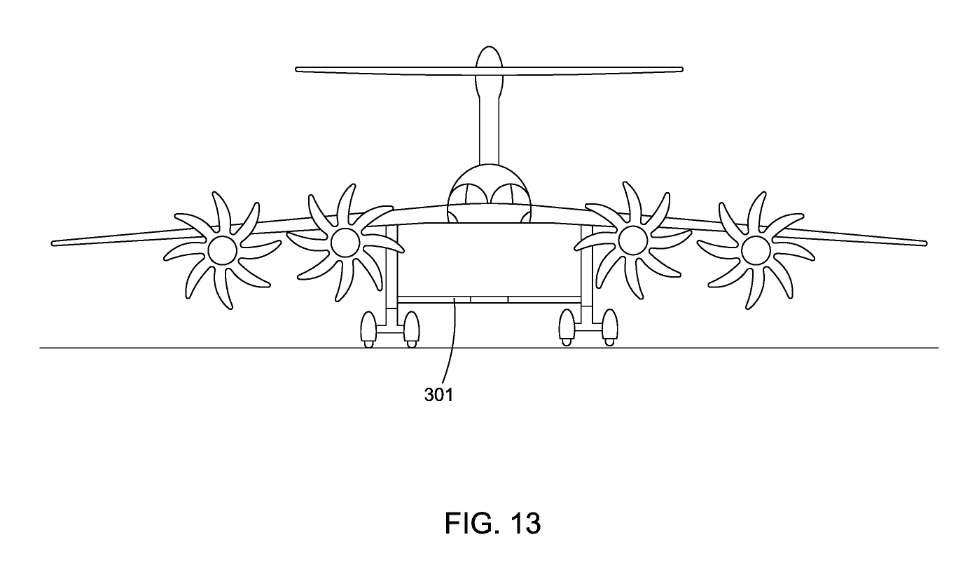

FIG. 13 is a front view of an exemplary payload transport aircraft 100 as shown in FIG. 1 without an attached payload interface system. In an embodiment, a wheel-strut stabilizing segmented cross-bar 301 can be attached between the two front wheel-struts 105. The cross-bar 301 can be mounted 90 degrees around its central axis to present a more aerodynamic profile without compromising its purpose.

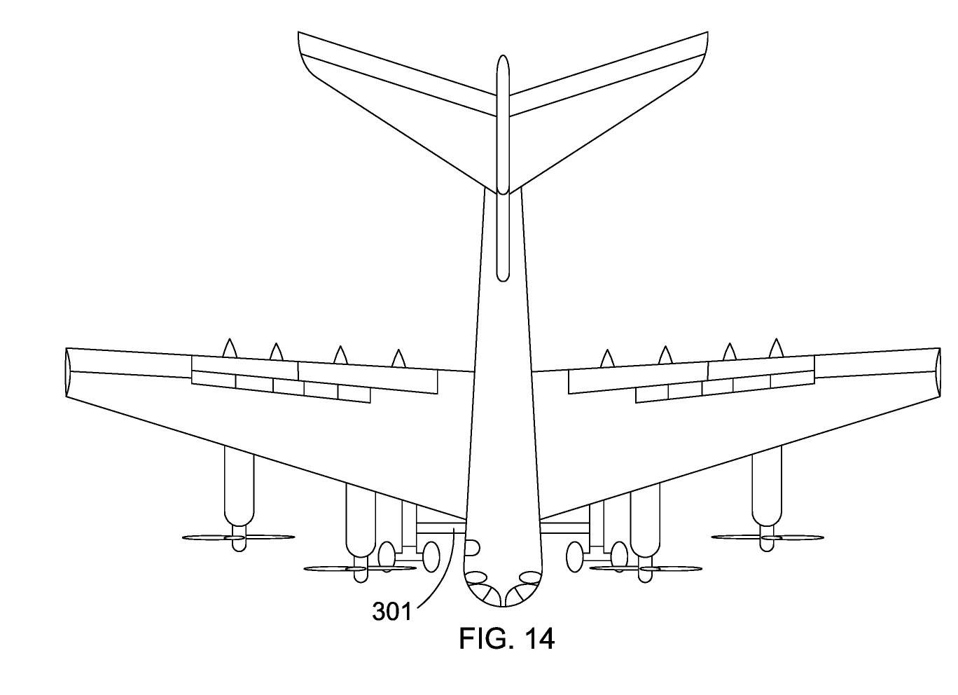

FIG. 14 is a top view of an exemplary payload transport aircraft 100 as shown in FIG. 1 without an attached payload interface system.

Although the invention has been described with reference to exemplary embodiments, it is not limited thereto. Those skilled in the art will appreciate that numerous changes and modifications may be made to an embodiments of the invention and that such changes and modifications may be made without departing from the true spirit of the invention.

What is claimed is:

1. A payload transport aircraft, comprising:
a nacelle comprising:
a cockpit;
a first fixed-wing extending in a first direction from beneath the cockpit; and
a second fixed-wing extending in a second direction from beneath the cockpit;
a first pair of wheel-struts extending between the first fixed-wing and a first set of corresponding wheels;
a second pair of wheel-struts extending between the second fixed-wing and a second set of corresponding wheels;
one or more wheel-strut stabilizing segmented cross-bars, each extending between a corresponding front wheel-strut and the rear wheel-strut on each side of the aircraft; and
a payload interface system.

2. The payload transport aircraft as recited in claim 1, wherein the payload interface system further comprises:
a plurality of movable engaging elements extending from the nacelle and wings and a rack comprising a pair of opposing side supports, each side support extending a length substantially perpendicular to the width and a plurality of teeth spaced from each other and extending from the pair of opposing side supports;
a plurality of cross supports extending a width between the first pair of wheel-struts and the second pair of wheel-struts;
wherein the plurality of teeth are configured to receive the plurality of engaging elements within spaces between the plurality of teeth; and
wherein the plurality of movable engaging elements are configured to lower the rack from the nacelle and wings, and raise the rack toward the nacelle and wings.

3. The payload transport aircraft as recited in claim 2, wherein the payload interface system further comprises:
a first fairing disposed at one end of the rack; and
a second fairing disposed at an opposite end of the rack;
wherein each fairing is configured to open to facilitate loading and unloading of the payload and close to facilitate enhanced aerodynamics during flight.

4. The payload transport aircraft as recited in claim 2, wherein the payload interface system further comprises:
a container engagement system configured to secure the payload to the rack.

5. The payload transport aircraft as recited in claim 1, wherein the payload interface system further comprises:
a plurality of movable engaging elements extending from the nacelle and wings; and
a payload holding compartment configured to receive the payload, comprising:
a top rack comprising:
a plurality of cross supports extending a width between the first pair of wheel-struts and the second pair of wheel-struts;
a pair of opposing side supports extending a length substantially perpendicular to the width; and
a plurality of teeth spaced from each other, extending from the pair of opposing side supports and configured to receive the plurality of engaging elements extending from the nacelle and wings to secure the payload to the nacelle and wings;
a bottom cargo deck comprising:
a plurality of cross supports extending a width between the first pair of struts and the second pair of wheel-struts; and
a pair of opposing side supports extending a length substantially perpendicular to the width; and
a pair of opposing side walls extending between the top rack and bottom cargo deck;
wherein the plurality of movable engaging elements are configured to lower the payload holding compartment from the nacelle and wings to the surface and raise the payload holding compartment toward the nacelle and wings.

6. The payload transport aircraft as recited in claim 5, wherein the payload holding compartment further comprises:
a main compartment body; and
expandable bellows disposed at opposing ends of the main compartment body;
wherein the expandable bellows are configured to expand and retract to facilitate payloads of different sizes.

7. The payload transport aircraft as recited in claim 5, wherein the payload holding compartment further comprises:
a first fairing disposed at one end of the payload holding compartment; and
a second fairing disposed at an opposite end of the payload holding compartment;
wherein each fairing is configured to open to facilitate loading of the payload into the holding compartment and unloading of the payload from the payload holding compartment and close to provide aerodynamics.

8. The payload transport aircraft as recited in claim 5, wherein the payload holding compartment further comprises:
a plurality of columns extending between the top rack and bottom cargo deck;
wherein the plurality of columns are configured to provide load paths to distribute a load exerted by the payload from the bottom cargo deck to the top rack.

9. The convertible payload transport aircraft as recited in claim 1, further comprising:
pivotable latches coupled to the first pair of wheel-struts and the second pair of wheel-struts,
wherein the pivotable latches are configured to pivot between upright standby positions and engaged locked positions to limit or prevent movement of the payload.

10. A payload transport aircraft, comprising:
a nacelle comprising a cockpit and an empennage;
a first wing extending out of one side of the nacelle;
a second wing extending out of the other side of the nacelle;
a pair of front fixed wheel-struts extending forward at an angle from the first wing and the second wing;
a pair of rear fixed wheel-struts extending down from the first wing and the second wing; and
one or more wheel-strut stabilizing segmented cross-bars extending between the front wheel-strut and the rear wheel-strut on each side of the aircraft.

11. The payload transport aircraft as recited in claim 10, wherein the first wing and the second wing are fixed to the nacelle in the same plane as the central axis of the nacelle.

12. The payload transport aircraft as recited in claim 10, wherein the first wing and the second wing are fixed to the nacelle at points located above the plane of the central axis of the main body.

13. The payload transport aircraft as recited in claim 10, wherein the first wing and the second wing are combined into a single fixed-wing attached beneath the nacelle.

14. The payload transport aircraft as recited in claim 10, wherein the rear wheel-struts are thicker than the front wheel-struts.

15. The payload transport aircraft as recited in claim 10, each wheel-strut stabilizing segmented cross-bar further comprising:
a rear segment and a front segment joined at a disconnection point by one or more coil-springs.

16. The payload transport aircraft as recited in claim 15, wherein the coil-springs can be tension springs resistant to stretching; and
wherein the coil-springs are mounted to each segment through the use of one or more spring mounting-posts fitted into each segment and protected using a transparent and removable cover.

17. The payload transport aircraft as recited in claim 15, wherein the one or more coil-springs are mounted to two sets of spring mounting-posts fitted with either side of the segments;
wherein the rear segment further comprises a rear segment attachment section for attachment to the rear wheel-strut through the use of a rear segment fastener; and
the front segment further comprises a front segment attachment section angled to match an angle of the front wheel-strut, which can attach to the front wheel-strut through the use of a front segment fastener.

18. The payload transport aircraft as recited in claim 15, wherein both the first segment and the rear segment are shaped at their respective termini in an “L” geometry.

19. The payload transport aircraft as recited in claim 10, further comprising:
a front wheel-strut stabilizing segmented cross-bar attached between the two front wheel-struts.

20. The payload transport aircraft as recited in claim 10, further comprising:
a payload interface system anchored to the front wheel-struts through one or more rigid interface system latches and anchored to the rear wheel-struts using one or more additional rigid interface system latches.
